(19) United States
(12) Patent Application Publication
(10) Pub. No.: US 2026/0332633 A1
(43) Pub. Date: Oct. 22, 2026

(54) RANSOMWARE PROTECTOR

(71) Applicant: BP International Limited, Middlesex (GB)

(72) Inventors: Ritesh Pravinkumar Patel, London (GB); Geoff Elton, London (GB)

(73) Assignee: BP International Limited, Middlesex (GB)

(21) Appl. No.: 19/652,598

(22) Filed: Apr. 20, 2026

Related U.S. Application Data
(60) Provisional application No. 63/791,787, filed on Apr. 21, 2025.

(51) Int. Cl. H04L 9/40

(52) U.S. Cl. CPC H04L 63/1433; H04L 63/145

(57) ABSTRACT

Methods, systems, and apparatus, including computer programs encoded on a computer storage medium, for protecting against ransomware are disclosed. In one aspect, a method includes the actions of determining that a first computing device is configured to connect to a first server and a second server. The actions further include determining that a second computing device is configured to connect to the first server, a third server, and a fourth server. The actions further include generating a graph that includes nodes that represent the computing devices and the servers and edges that represent the connections. The actions further include determining toxicity scores of the first and second computing devices. The actions further include determining first and second actions that are configured to reduce the first and second toxicity scores. The actions further include implementing the first action and the second action.

### CROSS-REFERENCE TO RELATED APPLICATION

This application claims benefit of U.S. Provisional Application 63/791,787 filed Apr. 21, 2025, and entitled “Ransomware Protector,” which is hereby incorporated herein by reference in its entirety for all purposes.

### STATEMENT REGARDING FEDERALLY SPONSORED RESEARCH OR DEVELOPMENT

Not applicable.

### BACKGROUND

Ransomware is a type of malware that permanently blocks access to the victim's personal data unless a “ransom” is paid. While some ransomware may lock the system without damaging any files, more advanced malware may use a technique called cryptoviral extortion. This technique encrypts the victim's files, making them inaccessible, and demands a ransom payment to decrypt them. Ransomware attacks may be carried out using a Trojan disguised as a legitimate file that the user is tricked into downloading or opening when it arrives as an email attachment.

### SUMMARY

An innovative aspect of the subject matter described in this specification may be implemented in a method for protecting against ransomware. The method includes the action of determining that a first computing device is configured to connect to a first server and a second server. The method further includes the action of determining that a second computing device is configured to connect to the first server, a third server, and a fourth server. The method further includes the action of generating a graph that includes a first node that represents the first computing device, a second node that represents the second computing device, a third node that represents the first server, a fourth node that represents the second server, a fifth node that represents the third server, a sixth node that represents the fourth server, a first edge that connects the first computing device and the first server, a second edge that connects the first computing device and the second server, a third edge that connects the second computing device and the first server, a fourth edge that connects the second computing device and the third server, and a fifth edge that connects the second computing device and the fourth server, based on the first computing device being configured to connect to the first server and the second server and the second computing device being configured to connect to the first server, the third server, and the fourth server. The method further includes the action of determining a first toxicity score of the first computing device, based on the first edge and the second edge, where the first toxicity score reflects a likelihood that the first computing device will infect other computing devices when infected with ransomware. The method further includes the action of determining a second toxicity score of the second computing device, based on the third edge, the fourth edge, and the fifth edge, where the second toxicity score reflects a likelihood that the second computing device will infect other computing devices when infected with ransomware. The method further includes the action of determining a first action that is configured to reduce the first toxicity score, based on the first toxicity score, the first edge, and the second edge. The method further includes the action of determining a second action that is configured to reduce the second toxicity score, based on the second toxicity score, the third edge, the fourth edge, and the fifth edge. The method further includes the action of implementing the first action and the second action.

Other implementations of this aspect include corresponding systems, apparatus, and computer programs recorded on computer storage devices, each configured to perform the operations of the method.

Other implementations of this aspect include corresponding systems, apparatus, and computer programs recorded on computer storage devices, each configured to perform the operations of the method.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates an example system, in accordance with principles described herein, that is configured to generate a graph that illustrates the risk of various client devices with regards to spreading ransomware.

FIG. 2 illustrates an example graph, in accordance with principles described herein, that illustrates the risk of various client devices with regards to spreading ransomware.

FIG. 3 is a flowchart of an example process, in accordance with principles described herein, for determining the risk of a client device with regards to spreading ransomware.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

In the following discussion and in the claims, the terms “including” and “comprising” are used in an open-ended fashion, and thus should be interpreted to mean “including, but not limited to . . . ” Use of the term “optionally” with respect to any element of a claim is intended to mean that the subject element is required, or alternatively, is not required. Both alternatives are intended to be within the scope of the claim. The term “couple” or “couples” is intended to mean either an indirect or direct connection. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

Protecting against ransomware may revolve around using data to identify points in a computing infrastructure where a ransomware infection would have a significant impact. In some cases, this may be done via a control perspective, i.e., which clients/servers do not have security controls running on them or have vulnerabilities. The solution described in this specification uses data mapping to show connections between devices, and map risk based on connections rather than volume of data flow.

The solution described in this specification views the connections from a graph connection view. This involves determining which clients are connecting to which servers, how many servers each client is connecting to and where the junction points are. This will focus on high risk devices and identify how ransomware would spread if any of specific client was infected.

By using existing data from other security controls, the solution generates a map of data flows, showing which clients are dangerous junction points between systems which ransomware can use to jump to other areas. The solution assigns each client a toxicity score based on what it could infect, and then compounds this score by using other data sources such as identifying any vulnerabilities or faulty controls on the devices. As an example, if a client is connected to one server, then it has a low toxicity score as it will only affect one server. If a client is connected to three separate servers, then it has high toxicity as the client can spread infection to the three servers.

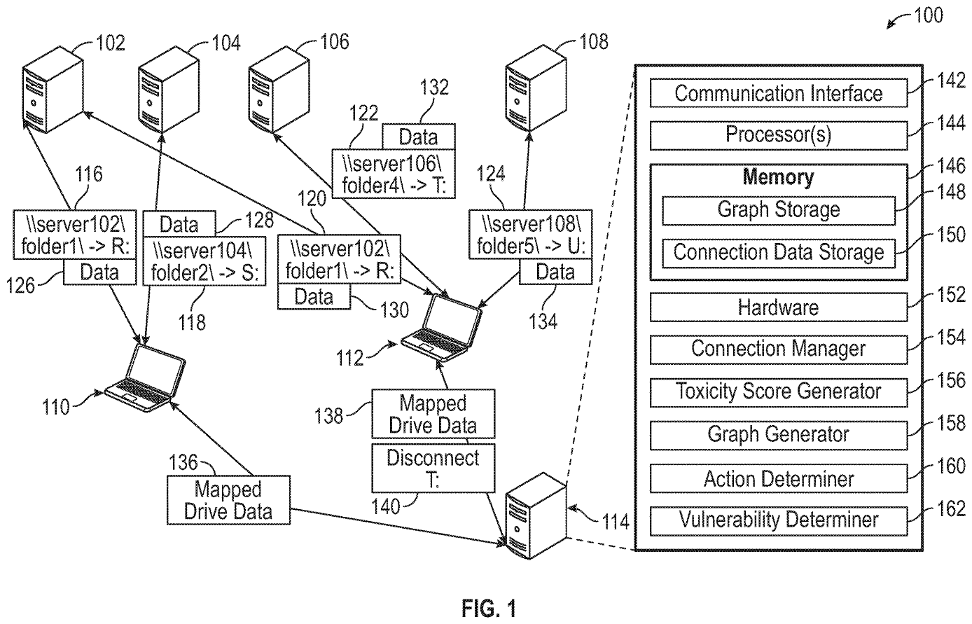

FIG. 1 illustrates an example system 100 that is configured to generate a graph that illustrates the risk of various client devices with regards to spreading ransomware. Briefly, and as described in more detail below, client computing devices 110 and 112 may be configured to communicate with servers 102, 104, 106, and 108. The computing device 114 may be configured to evaluate the connections between the client computing devices 110 and 112 and servers 102, 104, 106, and 108 to determine a risk that the client computing devices 110 and 112 will spread ransomware to other devices in the network. The computing device 114 may generate a graph to illustrate this risk.

In more detail, the client computing devices 110 and 112 may each be a computing device that is configured to communicate with other types of computing devices. For example, the client computing devices 110 and 112 may be a desktop computer, laptop computer, tablet, phone, smart device, and/or any other similar type of device. In the example of FIG. 1, the client computing devices 110 and 112 are laptops. Each of the client computing devices 110 and 112 may be configured to communicate with different servers. In some implementations, this communication may be through a mapped network drive. In some implementations, the client computing devices 110 and 112 may be configured to communicate with virtual or physical servers. These servers may be on the local network, on a remote network, and/or in the cloud.

In the example of FIG. 1, the client computing device 110 may have two mapped drives. The mapped drive 116 may map the folder1 of server 102 to the R: drive. The mapped drive 118 may map the folder2 of server 104 to the S: drive. The client computing device 112 may have three mapped drives. The mapped drive 120 may map the folder1 of server 102 to the R: drive. The mapped drive 122 may map the folder4 of server 106 to the T: drive. The mapped drive 124 may map the folder5 of server 108 to the U: drive.

The computing device 114 may be configured to analyze the connections from each of the client computing devices 110 and 112 and determine a risk that each client computing device 110 and 112 will spread ransomware if infected. The computing device 114 may be any type of computing device that is configured to communicate with other computing devices. The computing device 114 may communicate with other computing devices using a wide area network, a local area network, the internet, a wired connection, a wireless connection, and/or any other type of network or connection. The wireless connections may include Wi-Fi, short-range radio, infrared, and/or any other wireless connection. Some of the components of the computing device 114 may be implemented in a single computing device or distributed over multiple computing devices. Some of the components may be in the form of virtual machines or software containers that are hosted in a cloud in communication with disaggregated storage devices.

The computing device 114 may include a communication interface 142, one or more processors 144, memory 146, and hardware 152. The communication interface 205 may include communication components that enable the server 200 to transmit data and receive data from devices connected to the wireless carrier network. The communication interface 205 may include an interface that is configured to communicate with base stations of a wireless carrier network. The communication interface 205 may receive data that other devices transmit to the base stations and/or transmit data to the base stations for transmission to the other devices. In some implementations, the communication interface 142 may be configured to communicate over a wide area network, a local area network, the internet, a wired connection, a wireless connection, and/or any other type of network or connection. The wireless connections may include Wi-Fi, short-range radio, infrared, and/or any other wireless connection.

The hardware 152 may include user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 146 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. In some implementations, the data stored in the memory 146 may be stored externally from the computing device 114.

The one or more processors 144 may implement, through the execution of computer-executable instructions stored in the memory 146, a connection manager 154. The connection manager 154 may be configured to identify the various connections of client computing devices in a network. In some implementations, the network may be the devices managed by a business that may be on the same domain. The connection manager 154 may identify the client computing devices 110 and 112 along with other computing devices on the network. The connection manager 154 may provide a request to the client computing device 110 for the mapped drives on the client computing device 110. The client computing device 110 may respond to the request with the mapped drive data 136. The mapped drive data 136 may indicate that the client computing device 110 has mapped drive 116 and mapped drive 118. The connection manager 154 may provide a request to the client computing device 112 for the mapped drives on the client computing device 110. The client computing device 112 may respond to the request with the mapped drive data 138. The mapped drive data 138 may indicate that the client computing device 110 has mapped drive 120, mapped drive 122, and mapped drive 124.

The connection manager 154 may store the mapped drive data 136 and the mapped drive data 138 in the connection data storage 150. The connection manager 154 may also request information related to the data that moves through the drive mappings. This information may be related to the amount of data 126, 128, 130, 132, and 134 that moves through each of the drive mappings. The information may be related to the types of files in the data 126, 128, 130, 132, and 134 that move through each of the drive mappings. The information may be related to the frequency at which data 126, 128, 130, 132, and 134 moves through each of the drive mappings. The information may be related to the types of actions performed by the computing devices 110 and 112 on the data stored in the servers 102, 104, 106, and 108. The information may be related to the location of the client computing devices 110 and 112 before, during, and/or after the client computing devices 110 and 112 are connected and/or exchanging data over the mapped drives. The information may be related to the characteristics of the user of the client computing devices 110 and 112 before, during, and/or after the client computing devices 110 and 112 are connected and/or exchanging data over the mapped drives. The information may be related to the times when the mapped drives are connected. The information may be related to the requirements for the mapped drive to be active, for example, an active location connection to the network or a virtual private network connection. The connection manager 154 may store this data movement information in the connection data storage 150.

The one or more processors 144 may implement, through the execution of computer-executable instructions stored in the memory 146, a graph generator 158. The graph generator 158 may be configured to generate a graph that illustrates the connections between the client computing devices 110 and 112 and the servers 102, 104, 106, and 108. The graph may include a node for each of the client computing devices 110 and 112 and the servers 102, 104, 106, and 108 and an edge between each of the client computing devices and servers that are connected through a mapped drive. The number of edges that a client computing device has may be related to the risk that the client computing device poses to spreading ransomware. The graph generator 158 may store the graph in the graph storage 148.

In some implementations, the graph generator 158 may add additional data to each of the edges. The additional data may be related to the information related to the data that moves through the drive mappings and/or data related to the client computing devices 110 and 112. For example, the additional data may be related to the types of files that move through across the mapped drives, the characteristics of the user, the amount of data that moves across the mapped drives, and/or any other similar type of information described above.

The one or more processors 144 may implement, through the execution of computer-executable instructions stored in the memory 146, a vulnerability determiner 162. The vulnerability determiner 162 may be configured to analyze and identify potential vulnerabilities of the client computing devices 110 and 112. Some of the vulnerabilities may relate to faulty controls of the client computing devices 110 and 112.

In some implementations, the vulnerability determiner 162 may identify vulnerabilities and faulty controls using one or more of the following techniques. A first technique uses a vulnerability detection tool. This tool scans systems and applications for known vulnerabilities, such as outdated software, misconfigurations, and coding errors. This tool also provides reports detailing the identified vulnerabilities, their severity, and their potential impact. A second technique uses endpoint detection and response. Endpoint detection and response solutions monitor endpoint activity for suspicious behavior, such as malware execution, unauthorized access attempts, and anomalous network connections. Endpoint detection and response solutions can also detect vulnerabilities that are being actively exploited, which can provide real-time threat intelligence.

A third technique is a cloud native application protection platform tool. This tool provides visibility and security for cloud-native applications and infrastructure. This tool can also identify misconfigurations in cloud environments, vulnerabilities in containerized applications, and insecure API endpoints. A fourth technique involves user access exceptions. This technique monitors user access logs and identifies exceptions, such as excessive privileges or unauthorized access attempts, and can reveal weaknesses in access control policies. This technique analyses user behavior patterns can also help detect insider threats and compromised accounts. A fifth technique involves combining data sources. This technique correlates data from these multiple sources and provides a more complete picture of a system's security posture. For example, combining vulnerability scan results with endpoint detection and response data can help prioritize vulnerabilities that are being actively exploited. Combining sources allows a more in-depth view of the security posture.

The one or more processors 144 may implement, through the execution of computer-executable instructions stored in the memory 146, a toxicity score generator 156. The toxicity score generator 156 may be configured to determine the toxicity score of each of the client computing devices 110 and 112 and other client computing devices in the network. The toxicity score may reflect a level of risk that a client computing device poses to a network if the client computing device is infected with ransomware. The toxicity score may be based on the number of edges for a particular client computing device in the graph. The toxicity score may be further based on the data related to each edge. For example, the toxicity score generator 156 may generate a toxicity score for the client computing device 110 based on the two mapped drives and the characteristics of the data 126 and the data 128. The toxicity score generator 156 may generate a toxicity score for the client computing device 112 based on the three mapped drives, the characteristics of the data 130, 132, and 134, and/or the characteristics of a user of the client computing device 112. The characteristics of the user may be related to the position of the user within a company that operates the network and other demographic information.

There are various other factors that the toxicity score generator 156 uses to determine the toxicity score of each of the client computing devices 110 and 112 and other client computing devices in the network. Some of these factors may cause an increase in the toxicity score. A first factor may be the discovery of vulnerabilities and faulty security controls, which can directly increase a toxicity score. Other factors may be the severity of the vulnerability, its potential impact, and the likelihood of exploitation. For example, a critical vulnerability in a publicly accessible web application may result in a higher toxicity score than a low-severity vulnerability in an internal system.

There are also additional factors that can affect the toxicity score. A first factor is the severity of the vulnerability because critical vulnerabilities pose a greater risk than low-severity vulnerabilities. A second factor is the exploitability of the vulnerability because vulnerabilities that are easy to exploit increase the risk. A third factor is the asset value because vulnerabilities in critical assets, such as databases containing sensitive data, have a greater impact on toxicity scores. A fourth factor is the exposure of the corresponding system because publicly accessible systems with vulnerabilities have a higher risk. A fifth factor may be the effectiveness of the control because the presence of compensating controls can mitigate risk, but faulty controls increase it.

The toxicity score generator 156 may store the toxicity scores in the graph storage 148 along with each node. In the example of FIG. 1, the toxicity score generator 156 may determine that the toxicity score for the client computing device 110 is two. The toxicity score generator 156 may determine that the toxicity score for the client computing device 112 is three.

The one or more processors 144 may implement, through the execution of computer-executable instructions stored in the memory 146, an action determiner 160. The action determiner 160 may be configured to determine an action to reduce a level of risk that a client computing device poses to a network if the client computing device is infected with ransomware. The action determiner 160 may use various thresholds and/or ranges to determine an action. The action determiner 160 may also use the characteristics of the client computing device to determine an action. The action determiner 160 may select an action based on the characteristics of the user who uses the client computing device, such as the title or position of the user.

The action determiner 160 may select from various predetermined actions that may each correspond to a range for the toxicity score. For example, if the toxicity score is between six and nine, then the corresponding action may be to disconnect two mapped drives. The action determiner 160 may select the drives based on the data that moved between the client computing device and the server. The drives with the least amount of data traffic may be disconnected. As another example, if the toxicity score is between three and five, the corresponding action may be to disconnect two mapped drives. Other possible actions may include limiting a mapped drive to certain periods of time during the day, limiting a mapped drive to certain days, limiting a mapped drive to certain types of data movement, limiting a mapped drive to certain applications, and/or any other similar actions.

The selected action of the action determiner 160 may be configured to mitigate risk, which may have several benefits. First, addressing identified vulnerabilities and implementing effective security controls can reduce a system's risk score. Second, regular vulnerability assessments and penetration testing are essential for maintaining a low toxicity score. Third, continuous monitoring using the techniques describes above also helps to reduce a toxicity score.

In the example of FIG. 1, the action determiner 160 may determine that no action is necessary for client computing device 110. This determination may be based on the toxicity score of two being below a threshold of three. In addition, the action determiner 160 may use the characteristics of the data 132, the data 134, and the data 130 to select a mapped drive to disconnect. The action determiner 160 may determine to disconnect the mapped drive 122. The action determiner 160 may provide this action to the connection manager 154.

The connection manager 154 may be configured to determine whether to automatically perform the action or generate a recommendation to perform the action. The connection manager 154 may make this determination based on various factors such as the type of action, the characteristics of the data 132, the time period to perform the action, the characteristics of a user of the corresponding client computing device 112, and/or any other similar factors. In the example of FIG. 1, the connection manager 154 determines to automatically perform the action. The connection manager 154 generates disconnect instructions 140 that specify to disconnect the mapped drive 122. The connection manager 154 provides the disconnect instructions 140 to the client computing device 112. In some implementations, the connection manager 154 may provide a notification to a user of the client computing device 112 indicating automatic performance of the action.

The computing device 114 may continue to monitor the client computing devices 110 and 112 and other client computing devices. The computing device 114 may identify changes in mapped drives and determine additional actions to reduce the chances of ransomware spreading through the network. The computing device 114 may be configured to use a comprehensive approach to vulnerability management and barrier health tooling by using a variety of techniques and data sources. This approach helps to accurately assess and mitigate cybersecurity risks.

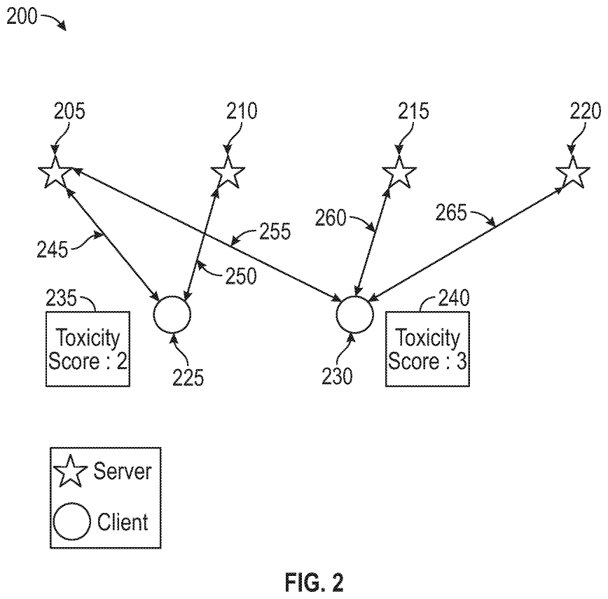

FIG. 2 illustrates an example graph 200 that illustrates the risk of various client devices with regards to spreading ransomware. The graph 200 includes various nodes and edges that represent the client computing devices and servers of FIG. 1 and the connections between them. The graph 200 may illustrate a small subset of the devices that make up a larger network of devices.

The graph 200 includes nodes 205, 210, 215, and 220 that represent the servers 102, 104, 106, and 108 of FIG. 1, respectively. The graph 200 includes nodes 225 and 230 that represent the client computing devices 110 and 112 of FIG. 1, respectively. The client computing devices 110 and 112 have various mapped drives to the servers 102, 104, 106, and 108. Edge 245 corresponds to mapped drive 116. Edge 250 corresponds to mapped drive 118. Edge 255 corresponds to mapped drive 120. Edge 260 corresponds to mapped drive 122. Edge 265 corresponds to mapped drive 124.

The graph 200 may include a toxicity score for each of the nodes 225 and 230 that represent the client computing devices 110 and 112. The toxicity score may be based on the number of connections that the nodes have to other devices. In the graph 200, the node 225 has two connections and a toxicity score 235 of two. The node 230 has three connections and a toxicity score 240 of three.

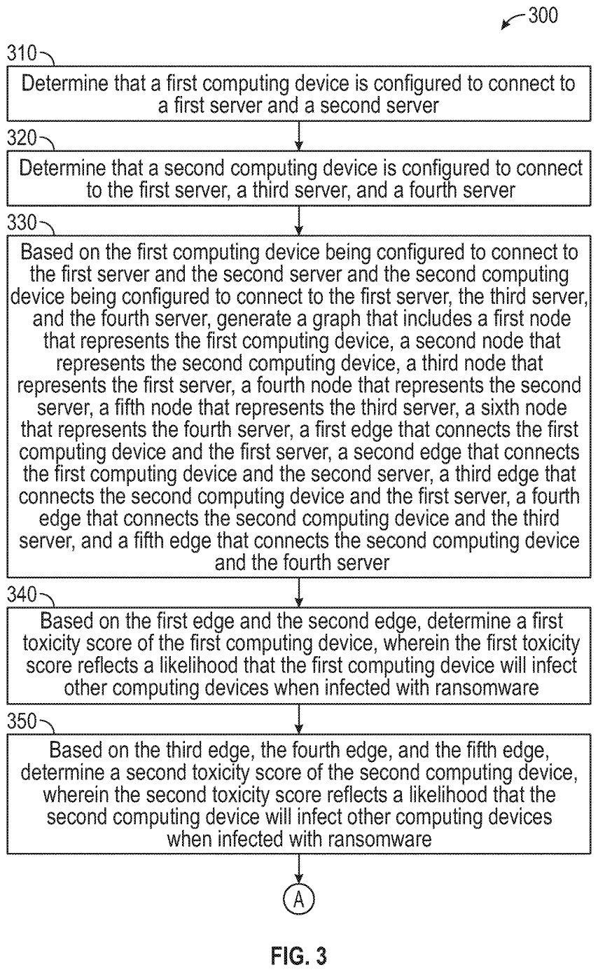

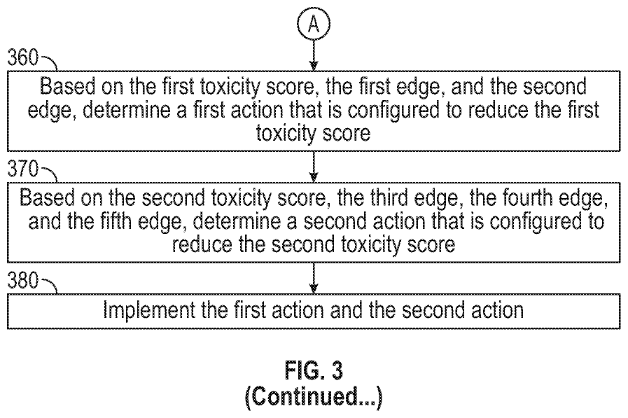

FIG. 3 is a flowchart of an example process 300 for determining the risk of a client device with regards to spreading ransomware. The process 300 identifies connections between client devices and servers. Based on those connections, the process 300 generates a graph that includes nodes for each of the client devices and servers and edges that represent the connections between the client devices and the servers. Based on the graph, the process 300 determines a toxicity score for each of the client devices. The reflects a likelihood that a client device will infect other devices when infected with ransomware. Based on the toxicity scores, the process 300 identifies one or more actions to reduce one or more of the toxicity scores. The process 300 may automatically perform the actions. The process 300 will be described as being performed by the computing device 114 and will include references to other components in FIG. 1. The process 300 may be performed by a single computing device, which may be a virtual device and/or split across multiple computing devices that may include virtual devices. In some implementations, the process 300 may be performed by an application that is running on the computing device 114.

The computing device 114 determines that a first computing device is configured to connect to a first server and a second server (310). In some implementations, the computing device 114 determines that the first computing device includes a first mapped drive that is configured to map to the first server and a second mapped drive that is configured to map to the second server.

The computing device 114 determines determining that a second computing device is configured to connect to the first server, a third server, and a fourth server (320). In some implementations, the computing device 114 determines that the second computing device includes a third mapped drive that is configured to map to the first server, a fourth mapped drive that is configured to map to the third server, and a second, or fifth, mapped drive that is configured to map to the fourth server.

In some implementations, the first computing device and the second computing device are with a same domain. In other words, the first computing device and the second computing device may communicate with an internal network of a company or other entity that operates or manages a network of computers.

Based on the first computing device being configured to connect to the first server and the second server and the second computing device being configured to connect to the first server, the third server, and the fourth server, the computing device 114 generates a graph that includes a first node that represents the first computing device, a second node that represents the second computing device, a third node that represents the first server, a fourth node that represents the second server, a fifth node that represents the third server, a sixth node that represents the fourth server, a first edge that connects the first computing device and the first server, a second edge that connects the first computing device and the second server, a third edge that connects the second computing device and the first server, a fourth edge that connects the second computing device and the third server, and a fifth edge that connects the second computing device and the fourth server (330).

The nodes and edges of the graph may also include some metadata. The nodes may include information related to the characteristics of the client computing device and/or the servers. The characteristics may include location data of the device that indicates the previous locations and movements of the device. The characteristics may include data indicating the type of device. The characteristics may also include data related to the user of the device, such as demographic data, human resources data, and/or any other similar user data. The edges may include information related to the data that moves across the mapped drive. This information may include an amount and frequency of the data movement, the type of data, the frequency and duration of the mapped drive connection, and/or any other similar data.

Based on the first edge and the second edge, the computing device 114 determines a first toxicity score of the first computing device, wherein the first toxicity score reflects a likelihood that the first computing device will infect other computing devices when infected with ransomware (340). In some implementations, the first toxicity score may be based on the number of edges connected to the node of the first computing device. In some implementations, the first toxicity score may be based on the metadata included in the node of the first computing device and/or the metadata included in the first edge and/or second edge.

Based on the third edge, the fourth edge, and the fifth edge, the computing device 114 determines a second toxicity score of the second computing device, wherein the second toxicity score reflects a likelihood that the second computing device will infect other computing devices when infected with ransomware (350). In some implementations, the second toxicity score may be based on the number of edges connected to the node of the second computing device. In some implementations, the second toxicity score may be based on the metadata included in the node of the second computing device and/or the metadata included in the third edge, the fourth edge, and/or the fifth edge.

In some implementations, the first and second toxicity scores may be proportional to the number of edges of the corresponding node. For example, the second toxicity score may be fifty percent higher than the first toxicity score because the second node has fifty percent more connections than the first node. The second toxicity score may be three because of the three edges of the second node, and the first toxicity may be two because of the two edges of the first node.

In some implementations, the first and second toxicity scores may be based on whether the first or second computing devices have faulty controls and/or vulnerabilities. For example, the computing device 114 may determine that the first computing device has faulty controls. In this case, the computing device 114 may increase the first toxicity score. As another example, the computing device 114 may determine that the second computing device does not have any faulty controls or vulnerabilities. In this case, the computing device 114 may leave the second toxicity score unchanged.

Based on the first toxicity score, the first edge, and the second edge, the computing device 114 determines a first action that is configured to reduce the first toxicity score (360). The computing device 114 may determine the first action based further on the metadata of the first edge, the metadata of the second edge, and/or the metadata of the node of the first computing device. For example, the first action may be to disconnect a mapped drive of the first computing device. In some instances, the computing device 114 may determine that no action is necessary based on the first toxicity score, the metadata of the first edge, the metadata of the second edge, and/or the metadata of the node of the first computing device.

Based on the second toxicity score, the third edge, the fourth edge, and the fifth edge, the computing device 114 determines a second action that is configured to reduce the second toxicity score (370). The computing device 114 may determine the second action based further on the metadata of the third edge, the metadata of the fourth edge, the metadata of the fifth edge, and/or the metadata of the node of the second computing device. For example, the second action may be to disconnect a mapped drive of the second computing device. In some instances, the computing device 114 may determine that no action is necessary based on the second toxicity score, the metadata of the third edge, the metadata of the fourth edge, the metadata of the fifth edge, and/or the metadata of the node of the second computing device.

The computing device 114 implements the first action and/or the second action (380). This implementation may be done automatically. In some implementations, the computing device 114 generate a recommendation for a user to implement the first action and/or the second action. The computing device 114 may determine whether to automatically implement an action based on preferences set by a user and/or the type of action. For example, an action that may have a limited effect on the user, such as disconnecting a mapped driving during periods of limited use. This type of action with a limited effect on the user may be implemented automatically. An action such as disconnecting a mapped driving during periods of high use, may not be implemented automatically.

While several implementations have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Also, techniques, systems, subsystems, and methods described and illustrated in the various implementations as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

Each and every claim is incorporated into the specification as an aspect of the present disclosure. Thus, the claims are a further description and are an addition to the aspects of embodiments disclosed herein. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A computer-implemented method, comprising:
determining that a first computing device is configured to connect to a first server and a second server;
determining that a second computing device is configured to connect to the first server, a third server, and a fourth server;
based on the first computing device being configured to connect to the first server and the second server and the second computing device being configured to connect to the first server, the third server, and the fourth server, generating a graph that includes a first node that represents the first computing device, a second node that represents the second computing device, a third node that represents the first server, a fourth node that represents the second server, a fifth node that represents the third server, a sixth node that represents the fourth server, a first edge that connects the first computing device and the first server, a second edge that connects the first computing device and the second server, a third edge that connects the second computing device and the first server, a fourth edge that connects the second computing device and the third server, and a fifth edge that connects the second computing device and the fourth server;
based on the first edge and the second edge, determining a first toxicity score of the first computing device, wherein the first toxicity score reflects a likelihood that the first computing device will infect other computing devices when infected with ransomware;
based on the third edge, the fourth edge, and the fifth edge, determining a second toxicity score of the second computing device, wherein the second toxicity score reflects a likelihood that the second computing device will infect other computing devices when infected with ransomware;
based on the first toxicity score, the first edge, and the second edge, determining a first action that is configured to reduce the first toxicity score;
based on the second toxicity score, the third edge, the fourth edge, and the fifth edge, determining a second action that is configured to reduce the second toxicity score; and
implementing the first action and the second action.

2. The method of claim 1, wherein:
determining that the first computing device is configured to connect to the first server and the second server comprises determining that the first computing device includes a first mapped drive that is configured to map to the first server and a second mapped drive that is configured to map to the second server, and
determining that the second computing device is configured to connect to the first server, the third server, and the fourth server comprises determining that the second computing device includes a third mapped drive that is configured to map to the first server, a fourth mapped drive that is configured to map to the third server, and a fifth mapped drive that is configured to map to the fourth server.

3. The method of claim 1, wherein the second toxicity score is fifty percent greater than the first toxicity score.

4. The method of claim 1, wherein the first computing device and the second computing device are within a same domain.

5. The method of claim 1, wherein the first action comprises preventing the first computing device from connecting to the first server or the second server.

6. The method of claim 1, wherein the second action comprises preventing the second computing device from connecting to the first server, the third server, or the fourth server.

7. The method of claim 1, comprising:
analyzing first data exchanged between the first computing device and the first server; and
analyzing second data exchanged between the first computing device and the second server,
wherein determining the first action that is configured to reduce the first toxicity score is further based on analyzing the first data and analyzing the second data.

8. The method of claim 1, comprising:
analyzing first data exchanged between the second computing device and the first server;
analyzing second data exchanged between the second computing device and the third server; and
analyzing third data exchanged between the second computing device and the fourth server,
wherein determining the second action that is configured to reduce the second toxicity score is further based on analyzing the first data, analyzing the second data, and analyzing the third data.

9. The method of claim 1, comprising:
determining whether the first computing device has a faulty control or vulnerability,
wherein the first toxicity score is further based on whether the first computing device has a vulnerability or faulty control.

10. The method of claim 1, comprising:
determining whether the second computing device has a faulty control or vulnerability,
wherein the second toxicity score is further based on whether the second computing device has a vulnerability or faulty control.

11. A system, comprising:
one or more processors; and
memory including a plurality of computer-executable components that are executable by the one or more processors to perform acts comprising:
determining that a first computing device is configured to connect to a first server and a second server;
determining that a second computing device is configured to connect to the first server, a third server, and a fourth server;
based on the first computing device being configured to connect to the first server and the second server and the second computing device being configured to connect to the first server, the third server, and the fourth server, generating a graph that includes a first node that represents the first computing device, a second node that represents the second computing device, a third node that represents the first server, a fourth node that represents the second server, a fifth node that represents the third server, a sixth node that represents the fourth server, a first edge that connects the first computing device and the first server, a second edge that connects the first computing device and the second server, a third edge that connects the second computing device and the first server, a fourth edge that connects the second computing device and the third server, and a fifth edge that connects the second computing device and the fourth server;
based on the first edge and the second edge, determining a first toxicity score of the first computing device, wherein the first toxicity score reflects a likelihood that the first computing device will infect other computing devices when infected with ransomware;
based on the third edge, the fourth edge, and the fifth edge, determining a second toxicity score of the second computing device, wherein the second toxicity score reflects a likelihood that the second computing device will infect other computing devices when infected with ransomware;
based on the first toxicity score, the first edge, and the second edge, determining a first action that is configured to reduce the first toxicity score;
based on the second toxicity score, the third edge, the fourth edge, and the fifth edge, determining a second action that is configured to reduce the second toxicity score; and
implementing the first action and the second action.

12. The system of claim 11, wherein:
determining that the first computing device is configured to connect to the first server and the second server comprises determining that the first computing device includes a first mapped drive that is configured to map to the first server and a second mapped drive that is configured to map to the second server, and
determining that the second computing device is configured to connect to the first server, the third server, and the fourth server comprises determining that the second computing device includes a third mapped drive that is configured to map to the first server, a fourth mapped drive that is configured to map to the third server, and a fifth mapped drive that is configured to map to the fourth server.

13. The system of claim 11, wherein the second toxicity score is fifty percent greater than the first toxicity score.

14. The system of claim 11, wherein the first computing device and the second computing device are within a same domain.

15. The system of claim 11, wherein the first action comprises preventing the first computing device from connecting to the first server or the second server.

16. The system of claim 11, wherein the second action comprises preventing the second computing device from connecting to the first server, the third server, or the fourth server.

17. The system of claim 11, wherein the acts comprise:
analyzing first data exchanged between the first computing device and the first server; and
analyzing second data exchanged between the first computing device and the second server,
wherein determining the first action that is configured to reduce the first toxicity score is further based on analyzing the first data and analyzing the second data.

18. The system of claim 11, wherein the acts comprise:
analyzing first data exchanged between the second computing device and the first server;
analyzing second data exchanged between the second computing device and the third server; and
analyzing third data exchanged between the second computing device and the fourth server,
wherein determining the second action that is configured to reduce the second toxicity score is further based on analyzing the first data, analyzing the second data, and analyzing the third data.

19. The system of claim 11, wherein the acts comprise:
determining whether the first computing device has a faulty control or vulnerability,
wherein the first toxicity score is further based on whether the first computing device has a vulnerability or faulty control.

20. One or more non-transitory computer-readable media storing computer-executable instructions that upon execution cause one or more processors to perform acts comprising:
determining that a first computing device is configured to connect to a first server and a second server;
determining that a second computing device is configured to connect to the first server, a third server, and a fourth server;
based on the first computing device being configured to connect to the first server and the second server and the second computing device being configured to connect to the first server, the third server, and the fourth server, generating a graph that includes a first node that represents the first computing device, a second node that represents the second computing device, a third node that represents the first server, a fourth node that represents the second server, a fifth node that represents the third server, a sixth node that represents the fourth server, a first edge that connects the first computing device and the first server, a second edge that connects the first computing device and the second server, a third edge that connects the second computing device and the first server, a fourth edge that connects the second computing device and the third server, and a fifth edge that connects the second computing device and the fourth server;
based on the first edge and the second edge, determining a first toxicity score of the first computing device, wherein the first toxicity score reflects a likelihood that the first computing device will infect other computing devices when infected with ransomware;
based on the third edge, the fourth edge, and the fifth edge, determining a second toxicity score of the second computing device, wherein the second toxicity score reflects a likelihood that the second computing device will infect other computing devices when infected with ransomware;
based on the first toxicity score, the first edge, and the second edge, determining a first action that is configured to reduce the first toxicity score;
based on the second toxicity score, the third edge, the fourth edge, and the fifth edge, determining a second action that is configured to reduce the second toxicity score; and
implementing the first action and the second action.
